(19) United States
(12) Patent Application Publication
(10) Pub. No.: US 2004/0197445 A1
(43) Pub. Date: Oct. 7, 2004

(54) Caramel coated food casing and method of manufacture

(76) Inventor: Douglas Edward Appleby, Danville, IL (US)

Correspondence Address: FISH & RICHARDSON P.C., 5000 BANK ONE CENTER, 1717 MAIN STREET, DALLAS, TX, 75201, US

(21) Appl. No.: 10/407,738

(22) Filed: Apr. 4, 2003

(51) Int. Cl. A23G 1/00

(52) U.S. Cl. 426/135

(57) ABSTRACT

The present invention relates to a food casing suitable to impart a caramel color to a portion of a food product, comprising a food casing having interior and exterior surfaces and a coating comprising caramel. The present invention also relates to methods of use of a food casing coated with a caramel coating and methods of manufacture.

### FIELD OF THE INVENTION

The present invention relates to a caramel-containing food casing and a method for manufacturing the casing. The invention further relates to uses for this casing.

### BACKGROUND OF THE INVENTION

This invention relates to a caramel-containing food casing and a method for manufacturing this food casing.

It is known that for certain food products enclosed in food casings, it is desirable to impart color to the casing and/or color and flavor to the encased food during the elevated temperature processing to cook the food.

21 C.F.R. § 73.85 identifies caramel as a color additive that is a “dark-brown liquid or solid material resulting from the carefully controlled heat treatment of the following food-grade carbohydrates: Dextrose, Invert sugar, Lactose, Malt syrup, Molasses, Starch Hydrolysates and fractions thereof and Sucrose.” Caramel liquid or solid color is dark-brown to black in color having an odor of burnt sugar and a pleasant, somewhat bitter taste. It is totally miscible with water and contains colloidal aggregates that account for most of its coloring properties, as well as its characteristic behavior toward acids, electrolytes and tannins.

There are four types of caramel color which are of commercial importance and which have distinctive applications in foods and beverages. Each type of caramel color has specific functional properties that ensure compatibility with a product and eliminate undesirable effects such as haze, flocculation and separation. The four types of caramel color are Caramel Color I (also known as Plain or Spirit caramel or CP caramel), Caramel Color II (Caustic sulfite caramel or CSC caramel), Caramel Color III (Ammonia or beer caramel, baker's and confectioner's caramel or AC caramel), and Caramel Color IV (known as sulfite-ammonia or soft drink caramel, acid proof caramel, SAC caramel or SD caramel).

Caramel color is prepared by the controlled heat treatment of carbohydrates. The carbohydrate raw materials are commercially available food-grade nutritive sweeteners which are the monomers, glucose and fructose, and/or polymers thereof (e.g., glucose syrups, sucrose and/or invert sugars, and dextrose). To promote caramelization, food grade acids, alkalis and salts may be employed in amounts consistent with Good Manufacturing Practice (GMP) and subject to the following stipulations. Ammonium and sulfite compounds cannot be used as reactants for Caramel Color I. Sulfite compounds must be used and ammonium compounds cannot be used as reactants for Caramel Color II. Ammonium compounds must be used and sulfite compounds cannot be used as reactants for Caramel Color III. Both ammonium and sulfite compounds must be used as reactants for Caramel Color IV. The ammonium compounds that are employed are ammonium hydroxide, carbonate, bicarbonate, phosphate, sulfate, sulfite and bisulfite. The sulfite compounds are sulphurous acid, and potassium, sodium and ammonium sulfites and bisulfites. The compounds that can be used for all four types of caramel color are sulfuric and citric acid, and sodium, potassium and calcium hydroxide. Food grade polyglycerol esters of fatty acids may be used as processing aids (antifoam) in amounts not greater than that required to produce the intended effect.

In order to produce a product that appears darker while on the meat, caramel color has been immobilized in the cellulose film. U.S. Pat. Nos. 4,778,639 and 4,756,914 describe a process for preparing these films and provide a comparison between immobilized caramel color and color applied to the surface.

U.S. Pat. No. 4,038,438 discloses impregnation of regenerated cellulose and collagen casings with caramel solutions. The caramel is then insolubilized by cross-linking. To promote the cross-linking in cellulose, a cationic thermosetting resin is used to cross-link the caramel into the cellulose to produce a nonextractable colored casing. U.S. Pat. No. 5,084,283 teaches methods for embedding caramel in a soluble film on the surface of the casing.

A problem with the aforementioned caramel-impregnated food casings is that it has been found that the presence of a caramel coating on the interior surface of a food casing, particularly in a cellulosic casing, can produce blocking and interfere with the opening of a flattened casing before the shirring step, or it can result in an uneven separation of the caramel coating between portions of the interior surfaces of the flattened casing when the casing is opened. An uneven coating can result in diminished consumer appeal for the food product. U.S. Pat. No. 4,219,574 addresses this problem by using an oil and surfactant based antiblocking agent. This patent also notes that blocking can also occur when the coated casing has been dried, since the caramel color is hydroscopic and absorbs moisture from the ambient air.

As discussed above, blocking of the inside of the casing by the caramel color causes the color to be pulled from the wall and leads to an uneven color distribution. This unevenness in color is a problem frequently encountered in caramel-containing casings.

It has also been observed that the aforementioned caramel-containing casing products display poor peeling characteristics. This occurs because preparation of the caramel from approved feed stocks results in the creation of a large number of low molecular weight products, some of which exhibit color and some of which are simple sugar by-products. This high solids content containing carbohydrates tends to hydrogen bond to water or other carbohydrate material, including the casing. As a result, the peelability characteristics of these casings tends to be poor.

### SUMMARY OF TIE INVENTION

The present invention relates to a food casing comprising a substantially uniform caramel coating on a surface of the casing, wherein said caramel coating comprises at least about 40% by weight of solids having a molecular weight greater than about 10,000.

The present invention also relates to a fractionated caramel composition for application on the surface of a food casing, wherein said composition comprises at least about 40% by weight of solids having a molecular weight greater than about 10,000.

The present invention further relates to a method for transferring a caramel color to a food product comprising coating a surface of a food casing with a fractionated caramel composition, wherein said composition comprises at least about 40% by weight of solids having a molecular weight greater than about 10,000; and contacting said surface with the food product.

The invention also relates to a method for treating a food casing to improve peelability of said casing from a food product contacting the casing, comprising coating a surface of the food casing with a fractionated caramel composition which comprises at least about 40% by weight of the solids having a molecular weight greater than 10,000, wherein said food surface contacts said food product.

### DESCRIPTION OF EMBODIMENTS

An embodiment of the present invention provides a food casing that is capable of transferring a dark brown or black caramel color evenly and consistently to the surface of a food product, e.g., the surface of a sausage. It has been found that this transfer can be accomplished by using a fractionated caramel composition comprising solid components, in which at least about 40% by weight of these solid components have a molecular weight greater than 10,000. In certain embodiments of the invention, the concentration of solid components in the fractionated caramel composition which have a molecular weight greater than 10,000 ranges from about 40 to about 99% by weight. In other embodiments of the invention, the concentration of solids having a molecular weight greater than 10,000 ranges from about 45 to about 95% by weight. In further embodiments of the invention, the concentration of solids having a molecular weight greater than 10,000 ranges from about 50 to about 95% by weight.

The fractionated caramel composition is coated on a surface of a food casing in a substantially uniform manner using any of the well known coating methods. As used herein, the term “food casing” is intended to encompass fibrous casings, non-fibrous casings, cellulose-based casings, non-cellulose-based casings, hydrated gel casings, dried casings and synthetic casings comprising nylon or polyester. Other casing materials that may be used are amylose, polyvinyl alcohol, regenerated cellulose, natural casings and collagen. The casings further typically may have inner or outer barrier coats and reinforcing materials. Casings believed particularly suitable for the invention are natural casings, collagen, regenerated cellulose and regenerated cellulose reinforced with fibrous cellulose paper or other reinforcing material. In an embodiment of the invention, a preferred food casing is a strippable regenerated cellulose casing. In other embodiments of the invention, the casing coated with the caramel composition of the invention is a reinforced fibrous casing. In other embodiments of the invention, the casing is in a shirred form.

In certain embodiments of the invention, the caramel composition is coated on a surface of the casing which contacts a food product. The caramel composition of the present invention facilitates the transfer of a uniform color to a food product contacting the coated surface of the casing. Following transfer to the surface of a food product, the fractionated caramel color provides a stable, even color on the surface of the food product that does not bleed when the food product is subjected to further processing or cooking. This embodiment of the invention can be used to meet the demand for food products, primarily meat products, having a “roasted” appearance.

An embodiment of the invention provides a method for transferring caramel color to a food product. This embodiment allows the cost-effective transfer of caramel to a food product without having to spray, dip or hand rub the caramel on the food product, thereby saving time and eliminating labor costs and sanitation costs associated with clean up.

An embodiment of the invention provides a fractionated caramel composition comprising at least about 40% by weight of solids having a molecular weight greater than 10,000. In certain embodiments of the invention, the concentration of solid components in the fractionated caramel composition which have a molecular weight greater than 10,000, ranges from about 40 to about 99% by weight. In other embodiments of the invention, the concentration of solids having a molecular weight greater than 10,000 ranges from about 45 to about 95% by weight. In further embodiments of the invention, the concentration of solids having a molecular weight greater than 10,000 ranges from about 50 to about 95% by weight.

An embodiment of the invention provides a fractionated caramel composition, which exhibits superior peelability characteristics when applied to a surface of a casing, where the coated surface contacts a food product.

An embodiment of the invention provides a method for treating a food casing to improve peelability of said casing from food product contacting the casing, comprising coating a surface of the food casing with a fractionated caramel composition which comprises at least about 40% by weight of the solids having a molecular weight greater than 10,000, wherein the food surface contacts the food product.

Another embodiment of the invention provides a method for transferring a caramel color to a food product comprising coating a surface of a food casing with a fractionated caramel composition, wherein the composition comprises about 40% by weight of solids having a molecular weight greater than about 10,000, and contacting the coated surface with a portion of the food product.

In an embodiment of the invention, the fractionated caramel composition is present at a range of about 0.1 to about 90% by weight of the casing. In other embodiments of the invention, the fractionated caramel composition is present at a range of about 5 to about 80% by weight of the casing.

An embodiment of the invention provides a fractionated caramel composition which comprises a total solids concentration ranging from about 5 to about 75% by weight. In other embodiments of the invention, the total solids concentration in the fractionated caramel composition ranges from about 10 to about 60% by weight.

In an embodiment of the invention, the fractionated caramel composition displays an absorbance at 610 nm (A₆₁₀), i.e., tinctorial power, of greater than about 0.3 (A₆₁₀>0.3). In a preferred embodiment of the invention, the A₆₁₀ of the caramel composition is greater than about 0.5. In another embodiment of the invention, the A₆₁₀ of the caramel composition is greater than about 1.0.

In an embodiment of the invention, the hue index or “redness” of the caramel composition, i.e., log (A₅₁₀/A₆₁₀)×10, ranges from about 3.4 to about 4.

An embodiment of the invention provides a fractionated caramel composition that may be mixed with liquid smoke without loss of natural smoke color and flavor. Mixtures of traditional caramel compositions and liquid smokes leads to the reduced application of one color or the other since the casing has a limited total absorption capacity. By mixing the fractionated caramel composition with liquid smoke, there is little dilution of the liquid smoke and a lower amount is needed to accomplish the color target.

In certain embodiments, the fractionated caramel composition of the present invention optionally comprises about 5 to about 35% by weight of propylene glycol. Certain embodiments of the invention optionally comprise about 5 to about 35% by weight of vegetable oils and their derivatives. These vegetable oils include, but are not limited to Durkex 500, soybean oil, cotton seed oil and mixtures thereof. Additionally, certain embodiments may optionally comprise one or more hydrocolloids at a range of about 0.5 to about 20% by weight including, but not limited to, cellulose derivatives such as carboxymethylcellulose, methylcellulose, methylhydroxyethylcellulose or hydroxypropylcellulose, alginates, pectins, carrageenans, Guar gums and mixtures thereof.

An embodiment of the invention provides an aqueous composition comprising a fractionated caramel composition comprising at least about 40% by weight of solids having a molecular weight greater than 10,000, and a concentration of water ranging from about 5 to about 90% by weight. In a preferred embodiment of the invention, the concentration of water ranges from about 60 to about 90% by weight.

The fractionated caramel compositions of the present invention present numerous advantages and improvements over known caramel compositions in the art. The fractionated caramel compositions of the present invention provide a higher color intensity over existing prior art compositions because they contain only the most intense color fraction as demonstrated by the high tinctorial power of the fractionated caramel. Furthermore, blocking of the casing is reduced by removing those portions of the caramel material that contain high levels of free sugars and carbohydrates. A casing coated with the fractionated caramel composition of the present invention displays reduced blocking compared to a casing coated with a non-fractionated commercial caramel composition.

Additionally, a darker smoked product can be obtained without compromising the natural smoke color and flavor because the fractionated caramel composition is concentrated and does not dilute the smoke. Lastly, the poor peeling characteristics exhibited by traditional prior art caramel compositions are reduced by eliminating the low molecular weight sugars from the starting material and concentrating the high molecular fractions, which act as a release agent in the same manner as known release agents such as hydrocolloids.

### WORKING EXAMPLES

Color Properties of Caramel Composition:

The table below sets forth a comparison of the tinctorial powers and hue indices of various caramel compositions.

TABLE 1

| | Tinctorial Power* | Hue Index |
|---|---|---|
| Solution | (A₆₁₀) | (log (A₅₁₀/A₆₁₀) × 10) |
| Commercial Caramel 050 | 0.129 | 4.143 |
| (30% solids)** | | |
| Fractionated Caramel | 0.506 | 3.715 |
| (25% solids in solution) | | |
| Fractionated Caramel | 0.310 | 3.474 |
| (10% solids in solution) | | |
| Fractionated Caramel | 1.701 | 3.973 |
| (Undiluted) | | |

*Tinctorial Power is defined as the absorbancy of a 0.1% w/v solution of caramel product at 610 nm measured in a cell (cuvette) having a 1 cm path length.
**Diluted to the range of solids similar to the fractionated caramel for comparison purposes. The solids concentration in the stock 050 commercial caramel is 60 to 65% by weight.

Peeling Properties of Caramel Composition:

The table below sets forth the peeling characteristics of caramel compositions.

TABLE 2

| | |
|---|---|
| Casing Without | Casing With |
| Peeling Treatment | Peeling Treatment |

| | Roast | | Roast | |
|---|---|---|---|---|
| Composition | Beef | Turkey | Beef | Turkey |
| Uncolored | 2 | 2 | 5 | 5 |
| Casing Control | | | | |
| Caramel Color | 0.5 | 3 | 5 | 5 |
| 050 | | | | |
| Fractionated | 4 | 4 | 5 | 5 |
| Caramel | | | | |

Table 2 represents the results obtained from an evaluation of casings in the absence and presence of peeling treatment using an internal grading scale from 0 to 5 with 5 being the best performing. The results show the problem of meat adhesion associated with standard commercial caramel and the superior release properties exhibited by fractionated caramel relative to the control casing and commercial caramel.

Experimental Study on Caramel Composition:

An experimental study was performed on the caramel composition of the present invention. Casing was coated with the caramel composition of the present invention and a commercially available caramel composition. The treated casings were shirred into stands and stuffed into four foot chubs with a Marlin sizer equipped with a 51 mm diameter horn and an available horn length of 31 inches. The four foot long pieces were prepared with approximately 10 inches of slack. The casings treated with the caramel composition of the present invention was “more dry” and did not smear in the same manner during the stuffing process as the casings coated with the commercially available caramel composition. As a result of the smearing, the casing coated with the commercially available caramel composition displayed a gradient of caramel color from one end of the casing to the other, i.e., darker at the closed end of the casing, and lighter at the open end of the casing. In contrast, the casing coated with the caramel composition of the present invention exhibited a uniform color throughout the casing.

After a period of time, usually 1-2 days, the above casings were peeled from the meat enclosed within the casings. The casing coated with the caramel composition of the present invention displayed excellent peelability from the meat product. In addition, an examination of the meat product following separation from the casing coated with the caramel composition of the present invention, revealed a uniform consistent coating of caramel on the meat product. In contrast, the casing coated with the commercially available caramel composition displays poor peelability characteristics and non-uniform transfer of caramel on to the meat product.

What is claimed is:

1. A coated food casing comprising a substantially uniform caramel coating on a surface of a food casing, wherein said caramel coating comprises at least about 40% by weight of solids having a molecular weight greater than about 10,000.

2. The coated food casing of claim 1, wherein said food casing is a fiber-reinforced cellulose casing.

3. The coated food casing of claim 1, wherein said coating is present at a range of about 0.1 to about 90% by weight of the casing.

4. The coated food casing of claim 1, wherein said coating is present on a surface of the food casing which contacts a food product.

5. The coated food casing of claim 1, wherein said coating is transferred to a food product which contacts the interior surface of said food casing.

6. The coated food casing of claim 1, wherein said coating further comprises about 5 to about 35% by weight of propylene glycol.

7. The coated food casing of claim 1, wherein said coating further comprises about 5 to about 35% by weight of one or more vegetable oils or their derivatives.

8. The coated food casing of claim 7, wherein said one or more vegetable oils are selected from the group consisting of Durkex 500, soybean oil, cotton seed oil and mixtures thereof.

9. The coated food casing of claim 1, wherein said coating further comprises one or more hydrocolloids.

10. The coated food casing of claim 9, wherein said one or more hydrocolloids are selected from a group consisting of carboxymethylcellulose, methylcellulose, methylhydroxyethylcellulose, hydroxypropylcellulose, alginates, pectins, carrageenans and Guar gums.

11. A food casing comprising a substantially uniform caramel coating on a surface of the food casing, wherein said caramel coating comprises about 40 to about 99% by weight of solids having a molecular weight greater than about 10,000.

12. A composition for application on the surface of a food casing, said composition comprising at least about 40% by weight of solids having a molecular weight greater than about 10,000.

13. The composition of claim 12, wherein said composition further comprises about 5 to about 35% by weight of propylene glycol.

14. The composition of claim 12, wherein said composition further comprises about 5 to about 35% by weight of one or more vegetable oils or their derivatives.

15. The composition of claim 14, wherein said one or more vegetable oils are selected from the group consisting of Durkex 500, soybean oil, cotton seed oil and mixtures thereof.

16. The composition of claim 12, wherein said composition further comprises one or more hydrocolloids.

17. The composition of claim 16, wherein said one or more hydrocolloids are selected from a group consisting of carboxymethylcellulose, methylcellulose, methylhydroxyethylcellulose, hydroxypropylcellulose, alginates, pectins, carrageenans and Guar gums.

18. The composition of claim 12, wherein said composition has a tinctorial power of greater than about 0.3.

19. The composition of claim 12, wherein said composition has a hue ranging from about 3.4 to about 4.

20. The composition of claim 12, wherein said composition has a total solids content ranging from about 5 to about 75% by weight.

21. A composition for application on the surface of a food casing, wherein said composition comprises from about 40 to about 99% by weight of solids having a molecular weight greater than about 10,000.

22. An aqueous composition for application on the surface of a food casing, wherein said composition comprises at least about 40% by weight of solids having a molecular weight greater than 10,000, and water ranging from about 5 to about 90% by weight.

23. A method for transferring a caramel color to a food product comprising coating a surface of a food casing with a fractionated caramel composition, wherein said composition comprises at least about 40% by weight of solids having a molecular weight greater than about 10,000; and contacting said surface with a portion of the food product.

24. The method of claim 23, wherein said composition further comprises about 5 to about 35% by weight of propylene glycol.

25. The method of claim 23, wherein said composition further comprises about 5 to about 35% by weight of one or more vegetable oils or their derivatives.

26. The method of claim 23, wherein said composition further comprises one or more hydrocolloids.

27. A method for treating a food casing to improve peelability of said casing from food product contacting the casing, comprising coating a surface of the food casing with a fractionated caramel composition which comprises at least about 40% by weight of solids having a molecular weight greater than 10,000, wherein said food surface contacts said food product.

28. The method of claim 27, wherein said composition further comprises about 5 to about 35% by weight of propylene glycol.

29. The method of claim 27, wherein said composition further comprises about 5 to about 35% by weight of one or more vegetable oils or their derivatives.

30. The method of claim 27, wherein said composition further comprises one or more hydrocolloids.

31. A coated food casing comprising a food casing and a layer of a fractionated caramel composition on a surface of the casing, wherein said composition comprises at least about 40% by weight of solids having a molecular weight greater than about 10,000, and said coated casing displays reduced blocking compared to a casing coated with an unfractionated caramel composition.
